(19) United States
(12) Patent Application Publication
(10) Pub. No.: US 2020/0156033 A1
(43) Pub. Date: May 21, 2020

(54) CATALYTIC REACTOR COMPRISING FIBROUS CATALYST PARTICLES SUPPORT

(71) Applicant: HALDOR TOPSØE A/S, Kgs. Lyngby (DK)

(72) Inventors: Roberta CENNI, Birkerød (DK); Emir ZAHIROVIC, Copenhagen NV (DK)

(21) Appl. No.: 16/632,957

(22) PCT Filed: Jul. 25, 2018
(86) PCT No.: PCT/EP2018/070207

§ 371 Date: Jan. 22, 2020

Related U.S. Application Data
(60) Provisional application No. 62/537,742, filed on Jul. 27, 2017.

(30) Foreign Application Priority Data
Aug. 7, 2017 (DK) PA 2017 00436

(51) Int. Cl. B01J 8/02; B01J 35/06; B01J 35/02; C10G 47/00; C10G 45/44; C10G 45/02

(52) U.S. Cl. CPC B01J 8/0278; B01J 8/0292; B01J 35/06; B01J 2208/00884; C10G 47/00; C10G 45/44; C10G 45/02; B01J 35/026

(57) ABSTRACT

The present disclosure relates to a reactor containing of catalyst particles, a layer of fibrous catalyst particles support below said catalyst particles and a lower means of structural support below said catalyst particles with the associated benefit of such a reactor having increased space for catalyst particles, compared to a reactor with inert particles supporting the catalyst particles.

### FIELD OF THE INVENTION

This invention relates to a catalytic reactor comprising a fibrous catalyst particles mesh material. The reactor can be a down-flow trickle flow catalytic reactor which includes at least one packed bed and sometimes a plurality of vertically superimposed packed beds of particulate catalytic material. This type of reactor is used in the petroleum and chemical processing industries for carrying out various catalytic reactions, such as sulphur and nitrogen conversion (HDS/HDN); hydrogenation of olefins (HYD) and aromatics (hydrodearomatisation—HDA), metals removal (hydrodemetallisation—HDM), oxygen conversion (hydrodeoxygenation—HDO) and hydrocracking (HC).

### BACKGROUND OF THE INVENTION

In the process industry there is a continuous quest to increase the overall activity of existing catalytic bed reactors. The benefits of a higher activity may be reaped in a wide variety of ways: from the ability to increasing the production or processing capacity, to decreasing the frequency of catalyst changeovers, processing more demanding feed, or producing products with improved qualities. A trivial solution to the need of a higher overall activity is to add a parallel reactor or replace a reactor with one having a larger volume, such that more catalyst particles can be accommodated inside. Costs and technical challenges of various order sometimes make this solution not viable.

In order to gain activity in a catalytic reactor without replacing it, catalyst suppliers devote intense research to improving the performance of the catalysts. Similarly, reactor internals are continuously developed to decrease the space required by the mechanical equipment without affecting its functionality.

A further general need of the process industry is that equipment maintenance is rapid. This is both because rapid maintenance implies higher plant availability, and because it involves shorter permanence time of a worker inside the equipment, in this case a reactor, which in turn improves overall safety.

As much as 2-10% of the volume available in a reactor is used for inert material retaining catalyst particles, and thus unavailable for catalyst. By replacing this material with a fibrous mat, having a ratio between width and thickness of at least 50:1, a significant increase in the volume available for catalyst particles may be obtained. In addition, a significant decrease of the time spent for maintaining a reactor may be achieved if the fibrous mat does not trap catalyst particles debris, or if it is so cheap that it can be disposed of and replaced after each cycle.

For the purpose of the present application a fibrous material shall be understood as a material made from fibres, which are interconnected in woven, knitted or non-woven form.

For the purpose of the present application metal wool shall be understood as a material consisting of entangled metal fibres.

For the purpose of the present application a fibrous non-woven material shall be understood as a material made from fibres, which are interconnected by entanglement.

For the purpose of the present application a fibrous thread shall be understood as a thread made from multiple fibres, which are interconnected by entanglement.

For the purpose of the present application a fibrous woven material shall be understood as a material woven or knitted from fibrous threads.

For the purpose of the present application a screen shall be understood as a non-fibrous structured metallic material with the function of retaining particles. The non-fibrous structured metallic material may be woven from single metal strains or made from other metal structures.

For the purpose of the present application a structural support shall be understood as material with the function of providing structural support to e.g. a screen or a fibrous material, without necessarily having a particle retaining ability.

For the purpose of the present application a catalytic cycle relevant to this discussion shall be understood as the time lagged between the loading and the removal of the catalytic particles.

For the purpose of the present application trickle flow shall be understood as a flow of a gas phase and a liquid phase over catalyst particles, and a trickle flow reactor shall be understood as a reactor suitable for such a flow.

For the purpose of the present application resistance to a flow of a gas/liquid mixture is determined as the pressure drop when a mixture comprises a gas and a liquid, where the gas has a viscosity of 0.017 cP and flowing through the fibrous catalyst particles support with a linear flow rate of 250 m/h; and the liquid has a viscosity of 0.15 cP, flowing through the fibrous catalyst particles support with a linear flow rate of 25 m/h

In a first embodiment the present disclosure relates to a reactor containing of catalyst particles, a layer of fibrous catalyst particles support below said catalyst particles and a lower means of structural support below said catalyst particles, wherein the ratio between width and thickness of the fibrous catalyst particles support is at least 50:1 and the fibrous catalyst particles support allows passage of a liquid, with the associated benefit of such a reactor having increased space for catalyst particles, compared to a reactor with inert particles supporting the catalyst particles.

In a further embodiment, said layer of fibrous catalyst particles support comprises oxide fibres, such as alumina, silica or borosilicates, with the associated benefit of such materials being stable and inert under a wide range of conditions.

In a further embodiment, said layer of fibrous catalyst particles support comprises non-oxide material, such as carbon fibre or metal wool, with the associated benefit of such materials being mechanically stable under a wide range of conditions.

In a further embodiment said layer of fibrous catalyst particles support comprises oxidic fibers as well as non-oxide material, with the associated benefit of such a fibrous catalyst particles support being thermally stable and structurally strong.

In a further embodiment said layer of fibrous catalyst particles support is a composite on fibre level, with the associated benefit of such a fibrous catalyst particles support being thermally stable and structurally strong.

In a further embodiment said layer of fibrous catalyst particles support is a layered composite comprising a layer of a material comprising oxidic fibres and a second layer comprising non-oxide fibres, with the associated benefit of such a fibrous catalyst particles support being thermally stable and structurally strong and simple to produce from existing materials.

In a further embodiment said layer of fibrous catalyst particles support provides retention for particles with a diameter above 0.1 mm, 0.5 mm or 1 mm, with the associated benefit of such a fibrous catalyst particles support retaining small catalyst particles, as well as debris of such particles, while having a minimal influence on the flow in said reactor.

In a further embodiment said layer of fibrous catalyst particles support provides a resistance to a flow of a mixture preferably below 1.5 kPa, even preferably below 0.7 kPa, and even preferably below 0.3 kPa when said mixture comprises a gas with a viscosity of 0.017 cP and flowing through the fibrous catalyst particles support with a linear flow rate of 250 m/h; and a liquid with a viscosity of 0.15 cP, flowing through the fibrous catalyst particles support with a linear flow rate of 25 m/h, with the associated benefit of such a support having minimal influence on the flow in the reactor, and minimizing the requirements for compressor power in the process.

In a further embodiment said reactor further comprises an upper means of structural support between said catalyst particles and said fibrous catalyst particles support, with the associated benefit of said upper means of structural support stabilizing the position of the fibrous catalyst particles support.

In a further embodiment said reactor further comprises a means for separating said upper means of support from said lower means of support by a difference of 2 mm, 6 mm or 20 mm, with the associated benefit of avoiding excessive compression of the fibrous catalyst particles support.

In a further embodiment said reactor further comprises a layer of inert particles between below said catalyst particles and above said fibrous catalyst particles support, with the associated benefit of distributing the mechanical load of catalyst particles over a wider area of said fibrous catalyst particles support.

In a further embodiment said reactor further comprises a non-fibrous screen, such as a single strand woven structure or a plate having cut slits positioned below said fibrous catalyst particles support, with the associated benefit of stabilizing said layer of fibrous catalyst particles support to better support the bed of catalyst particles above.

A further aspect of the present disclosure relates to the use of a fibrous material as a fibrous catalyst particles support retaining catalyst particles in a reactor bed of a trickle flow reactor, wherein the fibrous catalyst particles support is positioned below the bed of catalyst particles and above a structural support, with the associated benefit of using such a material over inert particles being a reducing requirement for reactor volume.

### DETAILED DESCRIPTION OF THE INVENTION

Some catalytic bed reactors use catalyst particles of very small size. In hydroprocessing reactors, for example, extrudates with a transversal dimension as small as 1/20 of an inch (1.27 mm) or smaller are frequent. In addition, comminution occurs in some cases, for example as a consequence of a non-optimal catalyst loading procedure. In order to avoid that tiny particles are carried through the outlet collector screen in the downstream equipment, a catalyst loading comprises inert material to separate the outlet collector from the catalyst bed. Inert material is often in the shape of sphere. We will refer to this material as inert particles in this document. Depending upon the size of the catalyst particles vs. the screen holes, more than one size of inert particles may be used. In this case, the inert particles loading pattern is chosen such to increase the size of the inert particles the further one moves from the catalyst particles towards the outlet collector screen. U.S. Pat. No. 4,968,651 A discloses a method to prepare inert ceramic support of improved characteristics and U.S. Pat. No. 4,229,418A discloses a method to use inert balls as a filter support.

The use of fibrous materials for catalyst support is known from gas phase reactors, but only for very specific applications.

U.S. Pat. No. 3,865,555A describes a multiple tube gas phase reactor, have a wire gauze skein as particles support. The height of the support is similar to the width individual tube.

U.S. Pat. No. 5,202,097A describes a radial flow gas phase reactor, in which a fibrous material is used a catalyst support and for directing the gas flow. The fibrous material is not permeable for the gas flowing in the reactor.

The same considerations apply for a catalyst particles support separating two beds in multiple bed reactors. A catalyst particles support comprises a structural support with screens, designed with similar consideration as an outlet collector screen. A bed loading of small-sized catalyst particles above a catalyst particles support as known from the art comprises at least one layer of inert particles between the catalyst particles and the screen of the catalyst particles support. Often, multiple layers of inert particles with different sizes are present, the smallest being in contact with the catalyst particles and the largest being in contact with the catalyst particles support screen.

Inert particles may be reused at the end of a catalytic cycle. However, most often inert particles are disposed of after a cycle.

Solid particles, comprising debris of catalyst particles and inert particles, have a tendency to get stuck in the openings of metallic screens, both on the catalyst particles support and on the outlet collector. The screens have to be thoroughly cleaned during a catalyst changeover, so that at the start of the operation the effluent flow is evenly distributed over the surface of the screen and the pressure difference across the reactor is not higher than anticipated from design. The cleaning operations for removing the solid particles stuck in the metallic screens tend to be long and cumbersome and thereby increase the downtime of the equipment and the time that operators spend in the confined space.

In the art, many types of metallic screens are available to retain the solid particulate. Some screens have a very fine mesh—so fine that, with the appropriate choice of a metallic screen, inert particles would not be necessary as a filter support. In practice, however, metallic screens with very fine mesh tend to be expensive. Furthermore, the complication and therefore the duration of the cleaning operations increase with the mesh fineness.

Therefore, there is a need for an inexpensive screening material, which is fine enough to retain catalyst particles with minimal or no use of inert particles as filter support, and which require minimal maintenance.

### SUMMARY OF THE INVENTION

The present disclosure describes a novel catalytic reactor comprising a fibrous catalyst particles support.

According to the invention, the fibrous catalyst particles support separates a structural support from particulate solid material or two layers of particulate solid material. In one embodiment, the fibrous catalyst particles support is laid between a screen and the inert particles. In another embodiment, the fibrous catalyst particles support is laid between a screen and catalyst particles. In a further embodiment, the fibrous catalyst particles support is laid between inert particles and catalyst particles. Depending upon the physical and mechanical properties of the fibrous catalyst particles support and upon the structural support design, in some embodiments it is possible to eliminate the screen and have the fibrous catalyst particles support resting on the structural supports.

Fibrous materials useful for the disclosure are impenetrable to catalyst particles and catalyst debris, but they are permeable to gas and liquid. Thus, they offer only a modest filter resistance to the flow of the effluents from the bed above. Fibrous materials useful for the disclosure may change shape during loading and/or during operations, this may cause an increase of the filter resistance. For example, the layer of fibrous catalyst particles support may be a sheet of fibrous material, such as a fiber mat, which in a vertical reactor may be compressed due to the catalyst weight upon loading. The sheet of fibrous material, may be compressed even further, during operations, due to the load of the processed feedstock. As one of the purpose of this disclosure is to introduce more catalyst in the reactor by filling with catalyst particles the space which is normally occupied by inert particles, the height of the fibrous catalyst particles support which replaces in full or in part the inert particles, as measured during and after catalyst loading, should be as low as possible. This has the further advantage to minimize the pressure drop across the fibrous catalyst particles support. Typical loadings of inert particles have a height in the range of 100-300 mm. The height of the fibrous catalyst particles support after compression is at least less than the loading height of inert particles, and preferably much shorter, for example 10-20 mm, or 6-10 mm, or even less than 6 mm.

Ideally, the flow resistance of a suitable fibrous catalyst particles support is so low that a reactor comprising a fiber mat has same or lower pressure drop compared to a reactor as known from the art, comprising the same loading of catalyst, but not part or all of the inert particles. However, it is not an ultimate requirement that the pressure drop across the fibrous catalyst particles support is lower than an equivalent layer of inert particles.

Fibrous materials suitable for the disclosure are inert in the reaction environment or they may have catalytic properties that support the activity and selectivity of the reaction or multiple reactions, which are intended to occur in the catalytic reactor. Inert in this context means that any side reaction caused by the fibrous catalyst particles support does not adversely affect the performances of the process in terms of product quality and yield such to render the performance of the invention un-economic.

Suitable fibrous materials are inexpensive and easy to dispose, such that at the end of a cycle the fibrous material may be disposed of and replaced by a new. This eliminates the need to cumbersome and lengthy cleaning operation of the screen.

There are numerous fibrous materials which possess the above mentioned properties, and therefore will be suitable for use in catalytic reactors, some examples are glass wools, fiberglass, ceramic mats or blankets, metal fibers, metal wool and synthetic materials. The materials used must of course be compatible with the conditions inside the process unit, in terms of temperature, reactants, flow and pressure. Ceramic mats or blankets fibers made for example by alumina, silica, borosilicate and other glass or ceramic materials are compatible with a great number of reactive environments. Metal fibers may be made for example from elemental metal or from alloys such as stainless steel, carbon fibers may be made from elemental carbon and synthetic polymer fibers may be made from e.g. aramides. Combination of these materials are also possible, for example as in metal-reinforced or carbon-reinforced fibres. Fibrous material suitable for the disclosure may contain non fibrous fillers to adjust the mechanical, physical and chemical properties of the material, for example the porosity.

According to the disclosure a fibrous catalyst particles support is positioned between a structural support or a screen and the catalyst particles. There are numerous ways of performing the invention: all the inert particles may be replaced by the fibrous catalyst particles support, which is in contact on the one side with the structural support/screen, and on the other side with the catalyst particles. Alternatively, only part (for example 1 layer out of 2 or 3 or more layers of inert particles) of the inert particles are eliminated and replaced by the fibrous catalyst particles support. In these embodiments the fibrous catalyst particles support is in contact with inert particles on one of the two sides or on both sides.

According to the present disclosure a larger volume is made available for the catalyst particles, providing a further benefit of greater flexibility in the selection and design of the catalyst loading.

### BRIEF DESCRIPTION OF THE DRAWINGS

The disclosure is further illustrated by the accompanying drawings showing examples of the prior art or examples of embodiments of the invention.

FIG. 1 shows an example of a loading diagram in a multi-layer three-bed reactor for hydroprocessing in the current art.

FIG. 2 shows an example of a loading diagram in a multi-layer three-bed reactor for hydroprocessing according to an embodiment of the invention.

### POSITION NUMBERS

01. Cylindrical reactor.
02. Large inert particles.
03. Medium inert particles.
04. Small inert particles.
05. Type 1 catalyst particles.
06. Type 2 catalyst particles.
07. Type 3 catalyst particles.
08. Type 4 catalyst particles.
09. Type 5 catalyst particles.
10. Type 6 catalyst particles.
11. Type 7 catalyst particles.
12. Type 8 catalyst particles.
13 Feed
14 Treat gas
15 Void
16 Quench
17 Effluent
20. Catalyst particles support.
21. Outlet collector.
22. Outlet pipe.
23. Distribution tray.
24,25,26 Fibrous catalyst particles support.
33 Large inert particles.
34 Small inert particles.
43 Large inert particles.
44 Small inert particles.

### DESCRIPTION OF THE DRAWINGS

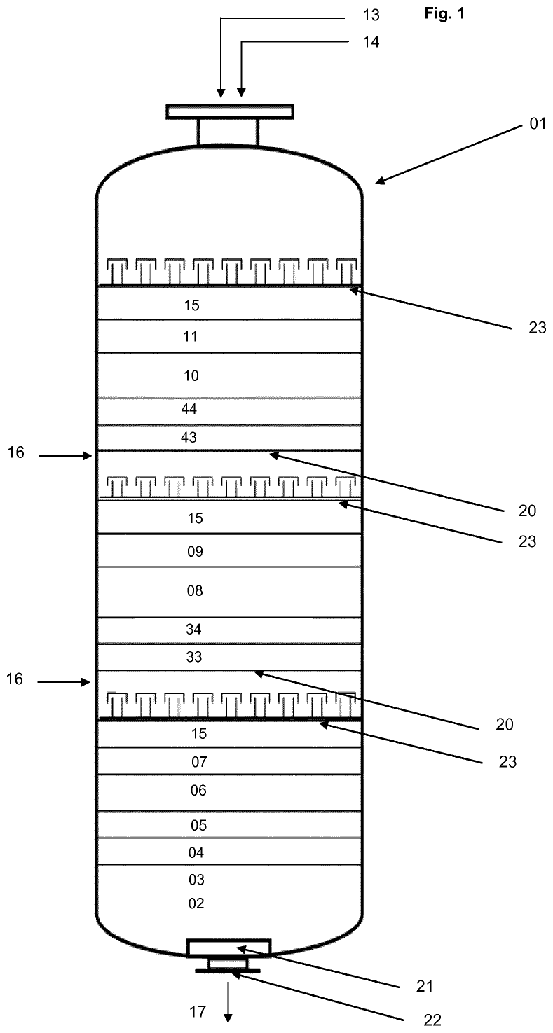

A catalytic bed reactor may comprise one or more catalytic beds. FIG. 1 shows an example of a catalytic bed from the art. The reactor of this example (01) receives a flow of feed (13) and treat gas (14), as well as two quench (16) streams for cooling and providing extra hydrogen. Effluent (17) is withdrawn at the reactor outlet (22). The reactor is a hydroprocessing reactor with 3 beds: a top (10,11), a middle (08,09) and a lower bed (05,06,07), all the three beds comprising multiple layers of catalyst particles (05-11). Above the beds are a distribution tray (23) and a void (15), allowing for mixing. The catalyst particles in the layers are not necessarily all different and do not necessarily all have catalytic properties—some of the catalyst particles may be selected because of physical properties and functionalities. The reactor furthermore comprises an outlet collector (21), at the exit of a reactor, typically at the bottom, as in FIG. 1. An outlet collector has the function to prevent catalyst particles from leaving the reactor and being transported to the downstream equipment through the outlet pipe (22). For this purpose, the outlet collector comprises a metallic screen (not shown). The outlet collector and the screen are subject to strength and durability requirements. The screen mesh is required to hold small catalyst particles and avoid unnecessary pressure differential across the outlet collector. A catalyst loading comprises inert particles to separate the outlet collector from the catalyst particles bed (02-04).

Each bed of the reactor further comprises a catalyst particles support (20). A catalyst particles support comprises a structural support with screens (not shown), designed with similar consideration as an outlet collector screen. A bed loading of a small-sized catalyst particles above a catalyst particles support as known from the art comprises at least one layer of inert particles between the catalyst particles and the screen of the catalyst particles support. In FIG. 1, there are two layers of inert particles, of type 34 and 44 (small and in contact with the catalyst particles), and of type 33 and 43, of intermediate size, in contact with the catalyst particles support screen

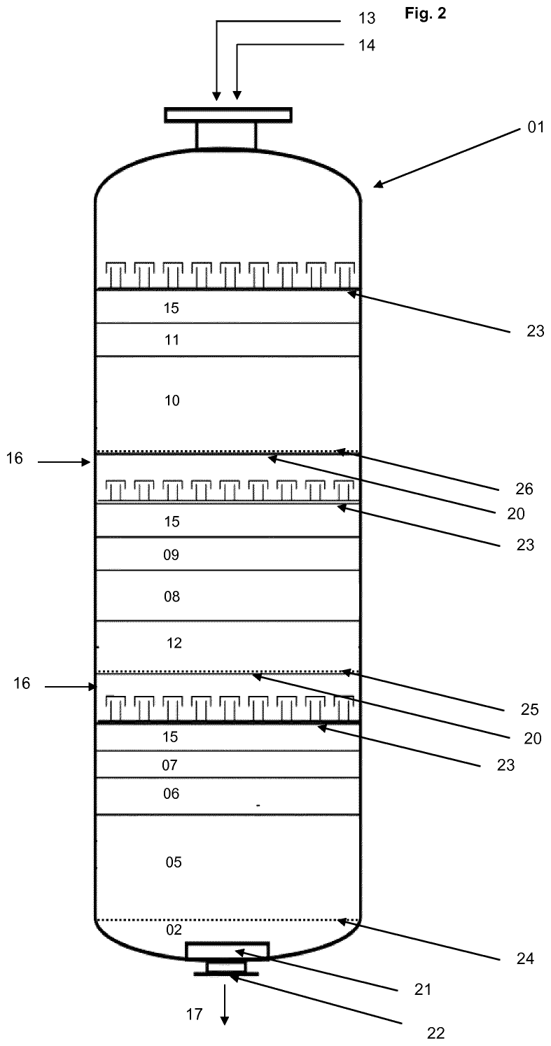

FIG. 2 shows an embodiment of the reactor according to the disclosure. Nomenclature is the same as in FIG. 1. The reactor (01) receives a flow of feed (13) and treat gas (14), as well as two quench (16) streams for cooling and providing extra hydrogen. Effluent (17) is withdrawn at the reactor outlet pipe (22). Also this reactor has distribution trays (23) and a voids (15), allowing for mixing. Fibrous catalyst particles support (24, 25, and 26) positioned on the catalyst support grid (20) replaces almost all of the inert particles (indicated with 03, 04, 33, 34, 43, 44 in FIG. 1) at the bottom of the three catalyst particles beds, leaving only a single layer (02). In other embodiments the fibrous catalyst particles support (24) may be laid on the screen of the outlet collector (21) replacing also the layer of inert particles (02). In this embodiment, a fibrous catalyst particles support (25, 26) is placed on top of the catalyst particles support holding the top bed (10,11) and the middle bed (08,09) and the catalyst particles bed is loaded directly on the fibrous catalyst particles support. In the embodiment, an additional volume of the same type of catalyst particles (10) may fill the space filled by the inert particles in FIG. 1 and not occupied by the catalyst particles screen for the top bed. With regards to the middle layer, a new catalyst type (12) fills the space left free by the inert particles and not occupied by the catalyst particles screen. With regards to the lower bed, the fibrous catalyst particles support (24) is placed above inert particles of the largest type (02) and allows to increase the height of catalyst particle layer (05).

The catalyst loading volume provided by replacing inert particles by fibrous catalyst particles support allows flexibility to the selection and design of the catalyst loading. This may result in a flexibility for increasing or decreasing the height of the layer of catalyst particle type 4 (08) in the middle bed of FIG. 2, relative to the same layer in FIG. 1, as appropriate for the optimization of the operations.

The fibrous catalyst particles supports (24, 25, 25) may be of the same type, but they may also be of different types depending upon the material that they have to retain and other characteristics required by the process.

### Example

The height of each layer for a hydroprocessing reactor as from the art is given in Table 1 (second column). If part of the inert particles is replaced by the fibrous catalyst particles support, as shown in the embodiment of FIG. 2 with respect to the current art loading of FIG. 1, the height available for the catalyst changes as in Table 1, third column. In this embodiment, the disclosure allows an increase of catalyst volume type 6 (layer 10) by 5.8%. Furthermore, the disclosure allows introducing a layer of 75+75-6 mm of catalyst particle type 8 (layer 12) below catalyst particle type 4 (08), being this layer 6.1% of the original layer of catalyst particle type 4 (08); and a further increase of catalyst volume of catalyst particle type 1 (05) by 18.7% at the bottom bed.

In addition, as the fibrous catalyst particles support is placed on top of the two catalyst particles supports, by means of the disclosure the maintenance operations concerned with cleaning the screens of the two catalyst particles supports become unnecessary, with consequent decrease of the reactor maintenance time.

TABLE 1

| | FIG. 1 | FIG. 2 |
|---|---|---|
| Layer position | Height (mm) | Height (mm) |
| 11 | 150 | 150 |
| 10 | 2480 | 2624 |
| 44 | 75 | — |
| 43 | 75 | — |
| 26 | — | 6 |
| 9 | 150 | 150 |
| 8 | 2340 | 2340 |
| 12 | — | 144 |
| 34 | 75 | — |
| 33 | 75 | — |
| 25 | — | 6 |
| 7 | 150 | 150 |
| 6 | 3330 | 3330 |
| 5 | 1090 | 1294 |
| 4 | 75 | — |
| 3 | 75 | — |
| 24 | — | 6 |
| 2 | 160 | 100 |

1. A reactor containing catalyst particles, a layer of fibrous catalyst particles support below said catalyst particles and a lower means of structural support below said catalyst particles, wherein the ratio between width and thickness of the fibrous catalyst particles support is at least 50:1 and the fibrous catalyst particles support allows passage of a liquid.

2. A reactor according to claim 1 in which said layer of fibrous catalyst particles support comprises oxide fibres.

3. A reactor according to claim 1 in which said layer of fibrous catalyst particles support comprises non-oxide material.

4. A reactor according to claim 1 in which said layer of fibrous catalyst particles support comprises oxide fibers as well as non-oxide material.

5. A reactor according to claim 4 in which said layer of fibrous catalyst particles support is a composite on fibre level.

6. A reactor according to claim 4 in which said layer of fibrous catalyst particles support is a layered composite comprising a layer of a material comprising oxide fibres and a second layer comprising non-oxidic fibres.

7. A reactor according to claim 1 in which said layer of fibrous catalyst particles support provides retention for particles with a diameter above 0.1 mm.

8. A reactor according to claim 1 in which said layer of fibrous catalyst particles support provides a resistance to a flow of a mixture below 1.5 kPa when said mixture comprises a gas with a viscosity of 0.017 cP and flowing through the fibrous catalyst particles support with a linear flow rate of 250 m/h; and a liquid with a viscosity of 0.15 cP, flowing through the fibrous catalyst particles support with a linear flow rate of 25 m/h.

9. A reactor according to claim 1 further comprising an upper means of structural support between said catalyst particles and said fibrous catalyst particles support.

10. A reactor according to claim 9 further comprising a means for separating said upper means of support from said lower means of support by a difference of 2 mm.

11. A reactor according to claim 1 further comprising a layer of inert particles between below said catalyst particles and above said fibrous catalyst particles support.

12. A reactor according to claim 1 further comprising a non-fibrous screen, such as a single strand woven structure or a plate having cut slits positioned below said fibrous catalyst particles support.

13. A method comprising using fibrous materials as a fibrous catalyst particles support retaining catalyst particles in a reactor bed of a trickle flow reactor, wherein the fibrous catalyst particles support is positioned below the bed of catalyst particles and above a structural support.

14. A reactor according to claim 2 in which said oxide fibres are alumina, silica, or borosilicates.

15. A reactor according to claim 3 in which said non-oxide material is carbon fibre or metal wool.

16. A reactor according to claim 7 in which said layer of fibrous catalyst particles support provides retention for particles with a diameter above 0.5.

17. A reactor according to claim 7 in which said layer of fibrous catalyst particles support provides retention for particles with a diameter above 1 mm.

18. A reactor according to claim 8, wherein said layer of fibrous catalyst particles support provides a resistance to a flow of a mixture below 0.7 kPa.

19. A reactor according to claim 8, wherein said layer of fibrous catalyst particles support provides a resistance to a flow of a mixture below 0.3 kPa.

20. A reactor according to claim 9 further comprising a means for separating said upper means of support from said lower means of support by a difference of 6 mm.

21. A reactor according to claim 9 further comprising a means for separating said upper means of support from said lower means of support by a difference of 20 mm.
